(19) United States
(12) Patent Application Publication
(10) Pub. No.: US 2026/0367396 A1
(43) Pub. Date: Nov. 19, 2026

(54) HEAD-UP DISPLAY DEVICE CAPABLE OF DETECTING SOLAR RADIATION CAPABLE OF HEATING THE IMAGE-GENERATING DEVICE THEREOF

(71) Applicant: Valeo Comfort and Driving Assistance, Créteil (FR)

(72) Inventor: Ayoub Ben-Nachouane, Créteil (FR)

(73) Assignee: Valeo Comfort and Driving Assistance, Créteil (FR)

(21) Appl. No.: 19/142,574

(22) PCT Filed: Dec. 12, 2023
(86) PCT No.: PCT/EP2023/085323

§ 371 Date: Jun. 23, 2025

(30) Foreign Application Priority Data
Dec. 23, 2022 (FR) FR2214413

(51) Int. Cl. G02B 27/01; B60K 35/23; B60K 35/65

(52) U.S. Cl. CPC G02B 27/0101; B60K 35/23; B60K 35/654; B60K 2360/23; G02B 2027/011

(57) ABSTRACT

Described is a head-up display device capable of detecting solar radiation that heats an image-generating device of the head-up display device. The head-up display device includes a device for generating images, in the form of a light beam, and an optical device having a mirror that reflects the light beam. The mirror is partially transparent to infrared radiation, and an electrical conductor is positioned behind the mirror. A temperature sensor is in contact with the electrical conductor.

### TECHNICAL FIELD OF THE INVENTION

The present invention relates to a head-up display device for a motor vehicle.

### TECHNOLOGICAL BACKGROUND

A head-up display (HUD) device is a driver-assistance device which makes it possible for the driver of a motor vehicle to take note of information without having to look away from the road.

For this purpose, a head-up display device usually comprises a device for generating images and an optical device. The device for generating images comprises a liquid-crystal display and a light source. The light source backlights the liquid-crystal display so as to create a pixelated light beam. The light beam is then deflected by the optical device, comprising one or more mirrors, to a partially transparent strip.

The strip is positioned within the field of vision of the driver when they are looking at the road, so as to make it possible for the driver to distinguish the road while at the same time viewing the information transmitted by the device for generating images in the form of a virtual image reflected on the strip. According to a known variant embodiment, the windshield may play the role of the strip in order to save material.

In a known manner, the intensity of the light beam generated by the device for generating images is adapted according to the ambient brightness, in order to make adequate perception of the virtual images by the driver possible.

However, at certain times of day, solar radiation follows the reverse path of the light beams emitted by the device for generating images. A rapid and significant rise in the temperature of the device for generating images is then observed. This uncontrolled heating phenomenon may lead to permanent deterioration of the device for generating images.

In order to prevent this phenomenon, it has been proposed to use a thermistor, placed against the liquid-crystal display, to locally evaluate the temperature on the surface of the liquid-crystal display. The operation of the device for generating images is then slaved to the values measured by the thermistor, so as to reduce the intensity of the light source backlighting the liquid-crystal display, in the event of excessive heating of said display.

According to the time of day and the position of the vehicle, the liquid-crystal display may be partially exposed to solar radiation. The temperature of the display may thus increase rapidly in the areas illuminated by solar radiation, heating then detected too late by the thermistor when it is not exposed to solar radiation. The liquid-crystal display may thus be permanently locally damaged before the thermistor detects an abnormal temperature rise.

In order to rectify this problem, it has been proposed to use several photodiodes, positioned behind a mirror of the optical device. Each photodiode is oriented in order to detect the incidence of solar radiation illuminating a distinct area of the mirror. The incidence of solar radiation on a portion of the mirror, and indirectly on a portion of the device for generating images, may then be detected earlier in order to prevent local and irreversible damage to the liquid-crystal display.

Nevertheless, this solution has the drawback of having to resort to a multitude of photodiodes, which are fragile and costly components. This solution also has the drawback of requiring complex wiring in order to connect each photodiode to a device for controlling the light source. According to another disadvantage, in order to make correct operation of the photodiodes possible, they must be positioned at a certain distance from the mirror, which requires a volume dedicated to the photodiodes to be provided behind the mirror. This solution is therefore not suitable when there is a desire to limit the bulk of the head-up display device.

The present invention aims to solve the technical problems mentioned above by proposing a head-up display device for a motor vehicle, which makes it possible to detect the incidence of solar radiation on the device for generating images of the head-up display device, in a safer, more economical manner and with less bulk.

### Subject Matter of the Invention

For this purpose, the invention proposes a head-up display device comprising a device for generating images in the form of a light beam, as well as an optical device comprising a mirror reflecting said light beam, the mirror being at least partially transparent to infrared radiation.

The invention is noteworthy in that an electrical conductor is positioned behind the mirror, and in that a temperature sensor is in contact with the electrical conductor.

The expression “positioned behind the mirror” refers to the positioning of the electrical conductor opposite a face of the mirror, facing the face of the mirror reflecting the light beam originating from the device for generating images.

The invention thus makes it possible to detect the incidence of solar radiation on the mirror, when the temperature sensor measures a rise in the temperature of the electrical conductor, which temperature rise is due to the absorption of a portion of infrared radiation passing through the mirror.

The use of an electrically conductive material advantageously makes rapid, or even very rapid, diffusion of heat in said material possible, so that the temperature of the electrical conductor is as a whole homogeneous or substantially homogeneous over time. Thus, partial exposure of the electrical conductor to infrared radiation will rapidly, or even instantaneously, lead to a significant rise in the temperature of the whole of the electrical conductor. As a result, the temperature sensor will be able to detect even partial exposure of the electrical conductor to infrared radiation more rapidly.

The invention thus makes it possible to identify scenarios in which the device for generating images is exposed to a critical sunshine level. It also makes it possible to quantify the intensity of the solar radiation illuminating the device for generating images.

With respect to the prior art mentioned above, the invention makes it possible to detect solar radiation which is incident on the mirror, using components which are less costly and less fragile than photodiodes.

Preferably, the electrical conductor is characterized by an electrical conductivity value which is equal to or greater than 10⁶ S·m⁻¹, preferably equal to or greater than 3×10⁷ S·m⁻¹.

According to one variant embodiment, the electrical conductor is preferably a metallic material such as copper, silver, tin or other.

According to one variant embodiment, in a plane which is parallel to the mirror, the surface area of the electrical conductor is greater than the surface area of the temperature sensor; preferably the surface area of the electrical conductor is at least 2 times, or even 10 times, greater than the surface area of the temperature sensor in order to increase the surface area for detection of infrared radiation by the electrical conductor. In other words, the temperature sensor partially covers the surface of the electrical conductor. The temperature sensor covers less than 30%, preferably less than 10%, of the surface of the electrical conductor.

According to one variant embodiment, the electrical conductor extends in a plane which is parallel or substantially parallel to the mirror. This embodiment promotes better exposure of the electrical conductor to the infrared radiation passing through the mirror.

According to one variant embodiment, the electrical conductor has a similar or substantially similar surface area to the mirror. Preferably, the electrical conductor is of sufficient thickness to form a rigid or substantially rigid plate.

Preferably, the electrical conductor extends in a plane which is parallel or substantially parallel to the mirror so that its exposure surface area is optimal for the infrared radiation passing through the first mirror.

According to one variant embodiment, the smallest distance between the electrical conductor and the mirror is between 0 and 5 mm, preferably between 0 and 1 mm.

According to one variant embodiment, the electrical conductor is supported by a plate. This embodiment advantageously makes it possible to reduce the amount of electrical conductor which is necessary, in order for the pattern formed by the electrical conductor to be mechanically resistant. The term “thickness” is understood to mean a measurement of the size of the electrical conductor in a direction which is perpendicular or substantially perpendicular to the plate.

According to another variant embodiment, the thermal conductivity of the plate is equal to or greater than 10 W·m⁻¹·K⁻¹, preferably equal to or greater than 20 W·m⁻¹·K⁻¹. Thus, the heat generated in a portion of the plate, exposed to infrared radiation and not covered by the electrical conductor, diffuses more rapidly to the electrical conductor in order to make it possible to detect solar radiation which is incident on the mirror. In other words, the plate may also make it possible to detect solar radiation, which is incident on an area of the mirror, which is not opposite the electrical conductor. In the ranges mentioned above, the plate therefore makes it possible to increase the surface area for detection of infrared radiation without increasing the surface area of the electrical conductor.

According to another variant embodiment, the head-up display device is protected from the external environment by a housing and the plate is distinct from said housing.

According to another variant embodiment, the head-up display device is protected from the external environment by a housing and the plate delimits a portion of said housing. This embodiment makes it possible to reduce the manufacturing cost of the invention, by using a wall of the housing protecting the optical device as a support plate.

According to another variant embodiment, the plate is positioned between the mirror and the electrical conductor. This embodiment advantageously makes it possible to conceal the electrical conductor behind the plate, in order for it not to be visible through the mirror.

Preferably, the plate is dark in color or black in color in order for it to be less visible through the mirror.

Preferably, the plate is in contact with the mirror in order to also serve as a support for the mirror. This embodiment makes it possible to increase the mechanical resistance of the mirror and, as a result, to reduce the phenomena of vibration of the mirror in running condition.

According to another variant embodiment, in a plane which is parallel to the mirror, the surface area of the plate is equal to or greater than 80% of the surface area of the mirror reflecting the light beam originating from the device for generating images, preferably equal to or substantially equal to the surface area of the mirror.

According to another variant embodiment, the electrical conductor is in contact with the mirror. Thus, the electrical conductor may advantageously act as a support or mechanical reinforcement for the mirror, notably in order to reduce the phenomena of vibration of the mirror in running condition.

According to another embodiment, the light beam originating from the device for generating images is polarized, and the surface of the mirror reflecting the light beam is covered by a polarizer the polarization of which is parallel or substantially parallel to the polarization of said light beam. This embodiment promotes optimal reflection of the light beam as well as increased transmission of a solar ray through the mirror.

According to another embodiment, the electrical conductor comprises at least one rectilinear or substantially rectilinear portion and/or at least one curved or substantially curved portion.

According to a preferred embodiment, the electrical conductor forms several intersecting lines and the ends of the lines are opposite the edges and/or corners of the mirror. This embodiment is particularly advantageous for detecting the presence of solar radiation on a peripheral area of the mirror.

According to another embodiment, in a plane which is parallel to the mirror, the surface area of the electrical conductor is equal to or greater than 30% of the surface area of the mirror reflecting the light beam, preferably equal to or greater than 90%. In other words, the electrical conductor may form a plate of a similar or substantially similar size to the mirror, so as to be able to absorb any solar radiation passing through said mirror.

According to one variant embodiment, several electrical sensors may be in contact with the electrical conductor so as to make it possible to more precisely and more rapidly detect local heating of the electrical conductor. This embodiment thus makes it possible to increase the detection sensitivity of the invention.

According to one variant embodiment, the temperature sensor is a thermistor. The thermistor may be adhesively bonded to or pressed against the electrical conductor.

According to one variant embodiment, the one or more temperature sensors are connected to a control unit configured to make the device for generating images operate in degraded mode when the temperature of the electrical conductor measured by the temperature sensor exceeds a predetermined value. By way of non-limiting example, degraded mode is understood to mean a reduction in the luminous intensity of the beam emitted by the device for generating images.

Of course, the various features, variants and embodiments mentioned above may be combined with one another in various combinations, insofar as they are not mutually exclusive or incompatible.

### DESCRIPTION OF THE FIGURES

The invention will be better understood by virtue of the below description, which relates to preferred embodiments given by way of non-limiting examples and explained with reference to the attached schematic drawings, in which:

FIG. 1 illustrates a schematic view of a cross section of a head-up display device according to the invention;

FIG. 2 illustrates a schematic and exploded view of a system for detecting solar radiation which is present in the head-up display device depicted by FIG. 1;

FIG. 3 illustrates several non-limiting variants of patterns formed by an electrical conductor on the surface of a plate of the detection system depicted by FIG. 2;

FIG. 4 illustrates a method for attaching a plate of the detection system depicted by FIG. 2;

FIG. 5 illustrates a schematic view of a cross section of one variant embodiment of a system for detecting solar radiation according to the invention;

FIG. 6 illustrates a schematic and exploded view of a detection system depicted by FIG. 5.

### DETAILED DESCRIPTION OF THE INVENTION

As a reminder, the invention proposes a head-up display device for a motor vehicle, making it possible to detect the incidence of solar radiation on a device for generating images of the head-up display device, in a safer, more economical and less bulky manner.

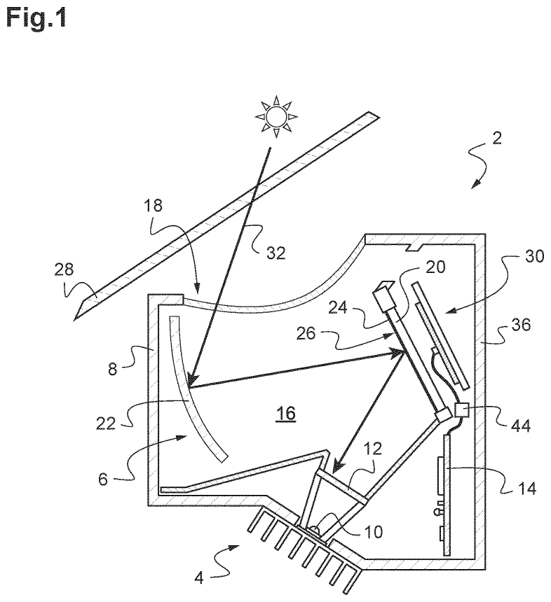

FIG. 1 illustrates a non-limiting example of an embodiment of a head-up display device according to the invention. In a known manner, the head-up display device 2 comprises a device 4 for generating images and an optical device 6, both placed in a housing 8 in order to protect them from the external environment.

The device 4 for generating images comprises a light source 10, backlighting a liquid-crystal display 12. The operation of the light source and the liquid-crystal display are synchronized by a control unit 14, so as to make it possible to project images in the form of a polarized light beam propagating in an optical chamber 16.

The optical device 6 of the display device makes it possible to direct the light beam to an opening 18 formed in the housing 8. For this purpose, the optical device comprises a first mirror 20, for example a folding mirror, reflecting the light beam originating from the device for generating images in the direction of a second mirror 22, for example a mirror having an optical power (such as a mirror of parabolic shape).

The first mirror 20 is characterized by an at least partial transparency to the infrared radiation composing the solar spectrum. By way of non-limiting example, the first mirror is composed of a transparent glass plate, on which a CMF (cold mirror film), marketed by 3M, is adhesively bonded. The CMF then forms the front face of the first mirror. More specifically, the CMF is composed of several thin layers, of the order of 300 layers, each layer being specific to a wavelength of the solar spectrum. The CMF is characterized by up to 80% transmission of infrared as well as up to 30% transmission of visible light.

A polarizer 24 is positioned opposite or indeed against a front face 26 of the first mirror, reflecting the light beam originating from the device for generating images, so as to promote optimum reflection of said light beam, itself polarized at the output of the liquid-crystal display 12.

The light beam reflected by the second mirror 22 is then projected through the opening 18, closed here by a transparent protective cover, to a partially transparent strip (here the windshield 28 of a motor vehicle) where the light beam is again reflected, this time in the direction of the eyes of the driver of the motor vehicle.

Thus, the driver of the motor vehicle is able to view, in front of the windshield 28, a virtual image defined by the information transmitted by the device for generating images.

At certain times of the day, solar radiation 32 may follow the reverse path of the light beam emitted by the device for generating images, and partially illuminate the liquid-crystal display 12. The device 4 for generating images may then rise in temperature, locally and abruptly. This phenomenon of uncontrolled heating may lead to permanent deterioration of the liquid-crystal display of the display device. In order to avoid this irreversible phenomenon, it is necessary to be able to detect partial illumination of the liquid-crystal display 12 by solar radiation 32 early in order, if necessary, to make the device 4 for generating images operate in a degraded mode and thus lower its temperature.

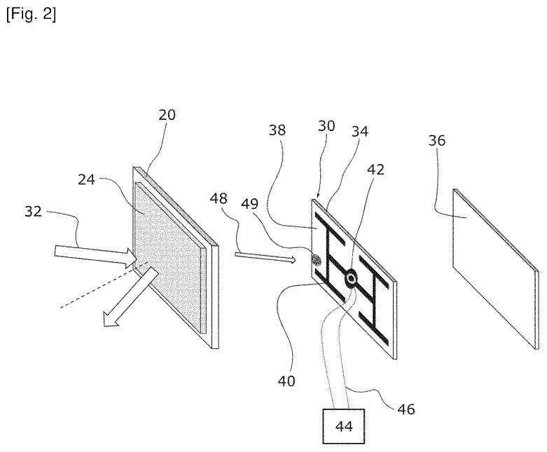

With this aim, the invention proposes to position, behind the first mirror 20, a system 30 for detecting solar radiation 32 as illustrated in FIG. 2. The detection system 30 is composed of a plate 34 placed between a wall 36 of the protective housing 8 and the first mirror 20, so that the plate 34 is parallel or substantially parallel to said mirror.

The dimensions of the plate 34 are similar or substantially similar to the first mirror 20. The plate 34 is made from a material the thermal conductivity of which is equal to or greater than 10 W·m⁻¹·K⁻¹, preferably equal to or greater than 20 W·m⁻¹·K⁻¹.

According to the present example, the plate is made from a thermoplastic material, reinforced with graphite, for better thermal conductivity. According to an alternative, the plate is made of aluminum.

The thickness of the plate, measured in a direction which is normal to one of its large faces, is between 1 mm and 5 mm, preferably between 1 mm and 2 mm.

As illustrated by FIG. 2, a front face 38 of the plate, facing the first mirror 20, is partially covered by an electrical conductor 40. The electrical conductor is characterized by an electrical conductivity which is equal to or greater than 10⁶ S·m⁻¹, preferably equal to or greater than 3×10⁷ S·m⁻¹. By way of non-limiting example, the electrical conductor may be made of metal: copper, silver, tin, etc.

According to the present example, the electrical conductor 40 reproduces the shape of an “H” which is centered on the front face 38 of the plate 34.

The detection system 30 also comprises a temperature sensor 42, a thermistor according to the present example, adhesively bonded to and in the middle of the central bar of the “H” formed by the electrical conductor 40. The thermistor 42 is connected to a measurement unit 44 via conductive wires 46. The measurement unit 44 is able to emit a control signal when the temperature sensor 42 detects a rise in the temperature of the electrical conductor 40 beyond a pre-stored threshold value.

When solar radiation 32 partially illuminates the first mirror 20, as illustrated by FIG. 2, a portion of the infrared radiation 48 composing solar radiation 32 passes through the first mirror 20. Infrared radiation 48 illuminates a portion of the plate 34, leading to heating of the plate in the area 49 exposed to infrared radiation. Because of the thermal conduction properties of the plate, the heat generated in the exposed area is rapidly transmitted to the electrical conductor 40. The electrical conduction properties of the electrical conductor are then modified significantly variations detected instantaneously by the thermistor 42.

When these variations exceed a threshold value, pre-stored by the measurement unit 44, the measurement unit transmits a control signal to the device 4 for generating images in order for it to operate in degraded mode in order to lower its temperature.

The detection system 30 according to the invention therefore makes it possible to prevent local and uncontrolled heating of the device for generating images due to partial exposure to solar radiation, using components which are simple, robust and economical with respect to the use of photodiodes as proposed by the state of the art.

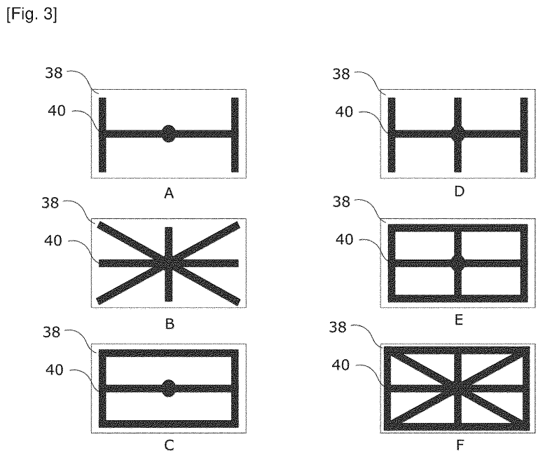

In order to make it possible to rapidly detect solar radiation illuminating a peripheral area of the device 4 for generating images, the electrical conductor 40 preferably covers one or more peripheral areas of the plate 34. FIG. 3 illustrates several non-limiting variants of patterns (A, B, C, D, E, F) formed by the electrical conductor 40 on the surface 38 of the plate 34.

According to a variant embodiment which is not illustrated, the detection system is arranged in the head-up display device so that the front face of the plate is opposite a wall of the protective housing. In other words, the large face of the plate not covered by the electrical conductor faces the mirror. This embodiment advantageously makes it possible for the pattern formed by the electrical conductor to not be visible through the first mirror. This embodiment makes it possible to ensure that the shape of the electrical conductor is not perceptible in the images viewed by the driver of the motor vehicle.

For the same reasons, according to another variant, the large face of the plate opposite the mirror is dark in color, preferably black in color. Optionally, the large face as well as the electrical conductor may be covered by a black layer.

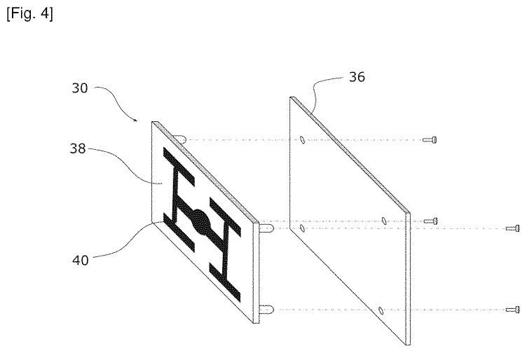

According to one variant embodiment, illustrated in FIG. 4, the plate may be screwed into a wall 36 of the protective housing in order to ensure that it does not generate vibrations when the vehicle is in a driving situation.

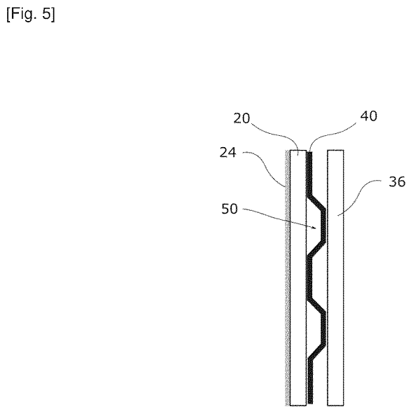

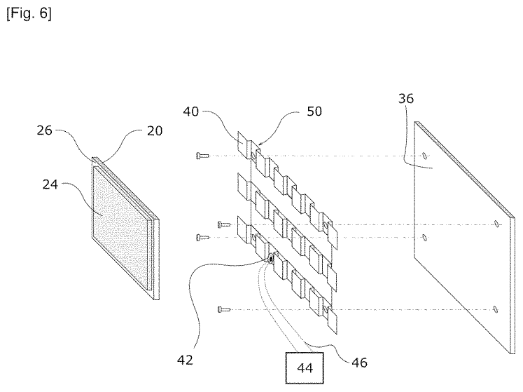

According to another variant embodiment, illustrated by FIGS. 5 and 6, the electrical conductor 40 may form a plate, of similar dimensions to the mirror, so that the presence of an additional plate to support the electrical conductor is not necessary. The plate formed by the electrical conductor 40 may comprise several recesses 50 intended to make it possible for the electrical conductor to be held at a distance from a wall 36 of the protective housing. The electrical conductor 40 may also act as a support for the first mirror 20, in order to hold the mirror firmly in the protective housing 8. This embodiment advantageously makes it possible to prevent the mirror as well as the electrical conductor, both held firmly in the housing, from being made to vibrate when the vehicle is moving.

1. A head-up display device comprising:
means for generating images in the form of a light beam;
an optical device comprising a mirror reflecting the light beam, the mirror being at least partially transparent to infrared radiation ,
wherein an electrical conductor is positioned behind the mirror and in that a temperature sensor is in contact with the electrical conductor.

2. The head-up display device as claimed in claim 1, wherein the electrical conductor is characterized by an electrical conductivity value which is equal to or greater than 10⁶ S·m⁻¹.

3. The head-up display device claimed in claim 1, wherein in a plane which is parallel to the mirror, a surface area of the electrical conductor is greater than a surface area of the temperature sensor.

4. The head-up display device as claimed in claim 1, wherein the electrical conductor extends in a plane which is parallel or substantially parallel to the mirror.

5. The head-up display device as claimed in claim 4, wherein the electrical conductor has a similar or substantially similar surface area to the mirror.

6. The head-up display device as claimed in claim 1, wherein the electrical conductor is supported by a plate.

7. The head-up display device as claimed in claim 6, wherein the thermal conductivity of the plate is equal to or greater than 10 W·m⁻¹K⁻¹.

8. The head-up display device as claimed in claim 6, wherein the display device is protected from the external environment by a housing and the plate is distinct from the housing.

9. The head-up display device as claimed in claim 6, wherein the display device is protected from an external environment by a housing and the plate delimits a portion of the housing.

10. The head-up display device as claimed in claim 6, wherein the plate is positioned between the mirror and the electrical conductor.

11. The head-up display device as claimed in claim 6, wherein in a plane which is parallel to the mirror, a surface area of the plate is equal to or greater than 80% of a surface area of the mirror reflecting the light beam.

12. The head-up display device as claimed in claim 1, wherein the electrical conductor is in contact with the mirror.

13. The head-up display device as claimed in claim 1, wherein the light beam originating from the device for generating images is polarized, and in that a surface of the mirror reflecting the light beam is covered by a polarizer the polarization of which is parallel or substantially parallel to the polarization of the light beam.

14. The head-up display device as claimed in claim 1, wherein the electrical conductor comprises at least one rectilinear or substantially rectilinear portion and/or at least one curved or substantially curved portion.

15. The head-up display device as claimed in claim 1, wherein in a plane which is parallel to the mirror, a surface area of the electrical conductor is equal to or greater than 30% of a surface area of the mirror reflecting the light beam.
